(19) United States
(12) Patent Application Publication
(10) Pub. No.: US 2025/0283771 A1
(43) Pub. Date: Sep. 11, 2025

(54) MODULAR PRESSURE SENSOR

(71) Applicant: ZF CV Systems Europe BV, Brussels (BE)

(72) Inventors: Thomas Bolik, Hannover (DE); Enno Hanisch, Barsinghausen (DE); Ariel Kotulski, Wroclaw (PL); Michal Wolanski, Wroclaw (PL)

(21) Appl. No.: 18/851,327

(22) PCT Filed: Mar. 29, 2022
(86) PCT No.: PCT/EP2022/058293

§ 371 Date: Sep. 26, 2024

(51) Int. Cl. G01L 19/00; F16H 59/68; F16H 63/30; G01L 9/06

(52) U.S. Cl. CPC G01L 19/0038; F16H 59/68; F16H 63/3023; G01L 9/06; G01L 19/0061; F16H 2059/683

(57) ABSTRACT

A modular pressure sensor (102)—includes a housing (104), a first side (106) of the housing (104) including a pressurized fluid inlet (108), and a second side (110) of the housing (104) being opposite to the first side (106). A spring-based electronic contact junction (140) on the second side (110)—is configured to transfer electronic signals representing pressure of the fluid received at the pressurized fluid inlet (108) to a flex foil or a printed circuit board (PCB). In an aspect, a gearbox actuator (100)—includes the modular pressure sensor (102) and the modular pressure sensor (102) is replaceably mounted onto the gearbox actuator (100).

### FIELD

The present disclosure relates to a modular pressure sensor. In particular, the present disclosure relates to a modular pressure sensor for a gearbox or a transmission actuator. For instance, the gearbox actuator mentioned herein may refer to the gearbox actuators used to engage varying transmission speeds associated with Automated Manual Transmission (AMT) of a commercial vehicle. It may be known that the gearbox actuators generally include one or more pneumatic actuators to facilitate engaging a particular gearset within the gearbox or transmission. In this context, the modular pressure sensor used according to the present disclosure finds use within the gearbox actuator or the transmission actuator used in association with the vehicle transmission or the gearbox, wherein the pressure signal present in one or more connecting lines within the gearbox actuator can be measured using the modular pressure sensor according to the present disclosure.

It should be noted that within the context of the present disclosure, the term “modular” refers to “interchangeability”, i.e., for instance, the capability of a service engineer to directly replace the pressure sensor without disturbing any other components to a device to which the pressure sensor is attached to. In particular, it should be possible to replace the pressure sensor without disturbing the electrical or electronic connections used as an interface between said pressure sensor and a device to which it is associated with.

The ability for the pressure sensor to be interchangeable i.e., to be replaced with a new one is even more important taking the context of the type of the pressure sensor used within the context of the present disclosure and the mode of connection e.g., through soldering performed at said interface.

### BACKGROUND

It is known from the prior art to use the pressure sensors as part of the gearbox actuators. However, there are certain points of improvement that are necessitated over the duration of development of the pressure sensors for sensing e.g., pneumatic or hydraulic pressure within the gearbox actuators.

One of the points of improvement in relation to the existing or conventional pressure sensors used in association with e.g., the gearbox actuators is that, when the pressure sensor is malfunctioning for any reason, the replacement of the pressure sensor involves certain difficulties including de-soldering one or more electric connection points that connect the pressure sensor and the electronic circuitry (such as a printed circuit board (PCB)) provided within the gearbox actuators. That may naturally be considered as one of the steps for replacing the pressure sensor. The further step would involve re-soldering the newly replaced pressure sensor with opposite connection points present at the electronic circuitry.

As can be realized, this would not only cost the gearbox actuator users in terms of “serviceability” or “interchangeability” in relation to the pressure sensors, but would complicate the process of standardizing the pressure sensors that are suitable to be used in the context of the gearbox actuators leading to less than preferable solutions available in e.g., the aftermarket replacements.

Additionally, when the conventional pressure sensor is soldered to e.g., connections of lead frames, or PCBs, or flex foil connections, the connection between the conventional pressure sensor and the lead frame connections or the PCBs or the flex foil connections is quite rigid. There is however a negative consequence associated with such rigidly mounted connections at electronic junctions. For instance, the gearbox or the vehicle transmission on the whole experience vibrations for a variety of reasons. Due to these vibrations, under certain circumstances, the soldering provided at the electronic junctions may disconnect after a certain period e.g., due to fatigue. Thus, the soldering is further undesirable when the pressure sensor may have to be replaced within e.g., the gearbox actuators because a re-soldered junction could render the connection further weaker potentially affecting the usable life.

Further objectives and the technical advantages associated with a variety of features of the present disclosure should be taken from the matter disclosed and/or claimed in the following sections.

### SUMMARY

In an embodiment of the present disclosure, a modular pressure sensor is disclosed, which includes a housing, a first side of the housing including a pressurized fluid inlet, and a second side of the housing being opposite to the first side. The modular pressure sensor further includes a spring-based electronic contact junction on the second side, wherein the spring-based electronic contact junction is configured to transfer electronic signals representing pressure of the fluid received at the pressurized fluid inlet either directly or indirectly to a lead frame or a flex foil or a printed circuit board (PCB). For instance, the technical advantage in accordance with the present embodiment is that, the spring-based electronic contact junction is provided to address the external or environmental factors that influence of the life of the product within the gearbox actuator such as temperature, humidity, pressure, force, and vibration. For another instance, another technical advantage of the present disclosure is that it enables the modularity or the interchangeability (see above for more) of the pressure sensor due to the usage of the spring-based electronic contact junction.

In particular, the movements generated by vibrations need to be compensated so that there are no cyclical stress factors or cyclical forces experienced at the junction between an output connection of an electronic component and the lead frame or the flex foil or the PCB caused, in particular due to the vibrations experienced at the transmission or the gearbox actuator. In conventional pressure sensors, the electronic contact junctions of the pressure sensors are typically soldered to wire traces originating from a PCB. Such soldered connections in general cannot withstand the vibrations over a longer period and may eventually fail. However, the determination of the pressure magnitude within the gearbox actuators are of high importance when it comes to e.g., vehicle transmission control. Thus, the lack of pressure readings (caused due to e.g., breakage of the soldered connections) could imply the pressure sensor failure to an Electronic Control Unit (ECU). The present disclosure thus prolongs the life of the pressure sensors by providing, among others, the spring-based electronic junction that could overcome the potential problems in the conventional pressure sensors.

In accordance with the same embodiment as the above or another embodiment, the spring-based electronic contact junction includes three springs on the second side of the housing, and the three springs are electronic contact poles representing a supply connection, a ground connection, and a signal output connection. For instance, by providing the springs at each of the electronic contact poles, the modular pressure sensor facilitates the technical advantages described above at each of these electronic contact poles.

Further, each of the three springs has a spring rate in the range of 2.5 N/mm to 5 N/mm.

In conjunction with the embodiment(s) discussed above, the three springs are made of stainless steel, and at least one of the three springs is gold plated. In particular the gold plating includes at least 0.1 micrometer of Gold (Au) and about 0.5 to 3 micrometer of Nickel (Ni).

In accordance with a still another embodiment of the present disclosure, the spring-based electronic contact junction is configured to compensate for the vibrations experienced by the modular pressure sensor between the frequency 20 to 2000 Hz. It is particularly noted that this frequency range of vibrations may find its relevancy in the context of, e.g., gearbox actuators, which is one of the potential areas of application of the modular pressure sensor according to the present disclosure. Thus, designing the modular pressure sensor and specifically, the characteristics of the spring-based electronic contact junction to withstand the vibrations of the above-mentioned frequency range may be of particular importance.

Furthermore, in the same or different embodiments as discussed above, the housing is manufactured by injection molding, and the modular pressure sensor includes at least two holes, which can be either threaded or non-threaded, wherein each of the at least two holes are configured to receive a fastener for attaching the modular pressure sensor to an external component. For instance, the at least two holes can be through holes such that on the one side a nut is insertable and the other side said nut is covered by a washer.

In an exemplary embodiment of the present disclosure, the modular pressure sensor of the present disclosure further includes one or more protrusions for positionally fixing the modular pressure sensor, with respect to an external component such as a gearbox actuator, after the assembly (of the pressure sensor itself).

In accordance with a preferred aspect of the present disclosure, the modular pressure sensor is a piezoresistive sensor. In the context of the usage of the modular pressure sensor being used in the gearbox actuators, the usage of the piezoresistive sensor offers a number of technical advantages such as high precision in readings, high tolerance for withstanding excess pressure, high sensitivity, higher range of operation i.e., pressure range, and smaller construction in relation to other types of pressure sensor. In the same or a different aspect of the present disclosure, the modular pressure sensor is either a relative or an absolute pressure sensor.

In conjunction with the embodiments discussed above or another embodiment, wherein the housing is made of a thermoplastic material incorporated with glass fiber. The technical advantage of using the glass fiber is that it may yield more flexibility in terms of shape of the housing as well as keep the housing chemically inert under the circumstance of the environmental factors of the gearbox actuator. For instance, oil and/or other fluid particles in combination with the impurities or foreign particles that get ingested into the environment of the gearbox actuators should not disturb the quality or the duration of the use of the housing. Furthermore, the housing is structurally more rigid and its physical properties such as stiffness and strength are enhanced due to the usage of glass fiber.

In accordance with the same or different embodiments discussed above, the modular pressure sensor is configured to operate in an operating temperature range of −40 to +130 degrees Celsius.

In an aspect of the present disclosure, a gearbox actuator, comprising the modular pressure sensor in accordance with any one of the above embodiments is disclosed, wherein the modular pressure sensor is replaceably mounted onto the gearbox actuator. In particular, the modular pressure sensor is replaceably mounted onto the gearbox actuator such that intrusive operations e.g., de-soldering or removal of bonded or welded wires are not required to be performed to demount or disassemble the modular pressure sensor from the gearbox actuator. For instance, as shown in the multiple embodiments of the present disclosure, a simple unscrewing operation of one or more fasteners is all that may be required to remove the modular pressure sensor from the gearbox actuator.

In a yet another aspect of the present disclosure, the gear box actuator further includes a printed circuit board (PCB), wherein the PCB is either directly or indirectly connected to the modular pressure sensor, and wherein the gearbox actuator additionally includes a wire trace for bridging the connection between the at least two springs and the PCB.

The technical advantages or further technical advantages of each of the aspects and/or embodiments discussed above can (also) be taken from the explanation or “detailed description” provided in association with the accompanying figures.

### BRIEF DESCRIPTION OF THE DRAWINGS

FIG. 1 illustrates a partial cross-sectional view of a modular pressure sensor when it is mounted on a gearbox actuator component in accordance with an embodiment of the present disclosure;

FIG. 2a illustrates a front view of a modular pressure sensor in accordance with an embodiment of the present disclosure;

FIG. 2b illustrates a top view of the modular pressure sensor explained in reference with FIG. 2a in accordance with an embodiment of the present disclosure; and

FIG. 2c illustrates a side view of the modular pressure sensor explained in reference with FIGS. 2a and 2b in accordance with an embodiment of the present disclosure.

### DETAILED DESCRIPTION

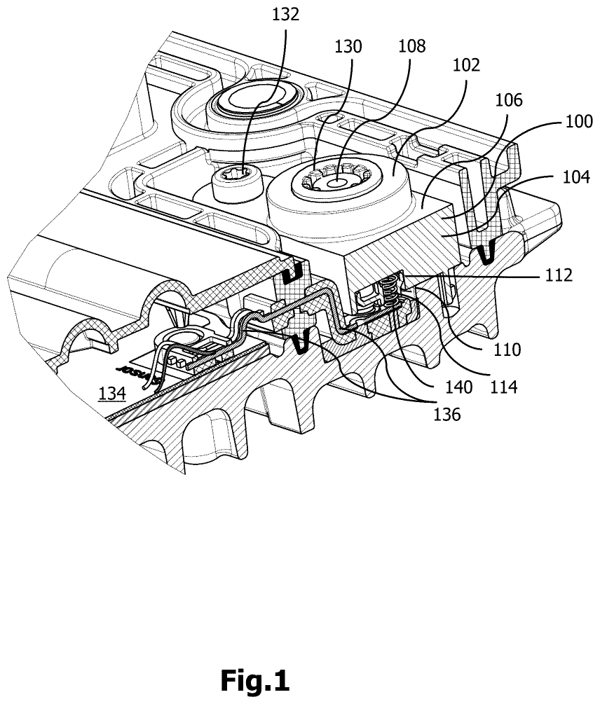

FIG. 1 illustrates a partial cross-sectional view of a modular pressure sensor 102 when it is mounted on a gearbox actuator component or gearbox actuator 100 in accordance with an embodiment of the present disclosure.

As can be noticed, in accordance with the present embodiment modular pressure sensor 102 includes a housing 104, a first side 106 of housing 104 including a pressurized fluid inlet 108, and a second side 110 of housing 104 being opposite to the first side 106. Furthermore, importantly, modular pressure sensor 102 includes a spring-based electronic contact junction 140 on second side 110 (of housing 104), wherein spring-based electronic contact junction 140 is configured to transfer electronic signals representing pressure of the fluid received at pressurized fluid inlet 108 either directly or indirectly to a lead frame or a flex foil or a printed circuit board (PCB). For instance, to facilitate the understanding, PCB is symbolically marked with the reference sign ‘134’ in FIG. 1. In accordance with the present disclosure, spring-based electronic contact junction 140 is provided to address the external or environmental factors that influence of the life of the product within gearbox actuator 100 such as temperature, humidity, pressure, force, and vibration.

In particular, by using spring-based electronic contact junction 140, the present disclosure achieves the technical effect of not only providing the electronic signals that represent the pressure of the fluid received at inlet 108, but it also negates the effects of the vibrations experienced at gearbox actuator 100. As may be envisaged, the gearbox actuators experience vibrations due to the environment in which they operate in. They are typically mounted on a gearbox or a vehicle transmission, which implies that any vibrations caused by the gearbox may, in a recognizable magnitude, will also get transferred to gearbox actuators 100. In conventional pressure sensors, the electronic contact junctions of the pressure sensors are typically soldered to wire traces originating from a PCB. Such soldered connections in general cannot withstand the vibrations over a longer period and may eventually fail. However, the determination of the pressure magnitude within the gearbox actuators are of high importance when it comes to e.g., vehicle transmission control. Lack of pressure readings could imply the pressure sensor failure. The present disclosure thus prolongs the life of the pressure sensors by providing, among others, spring-based electronic junction 140.

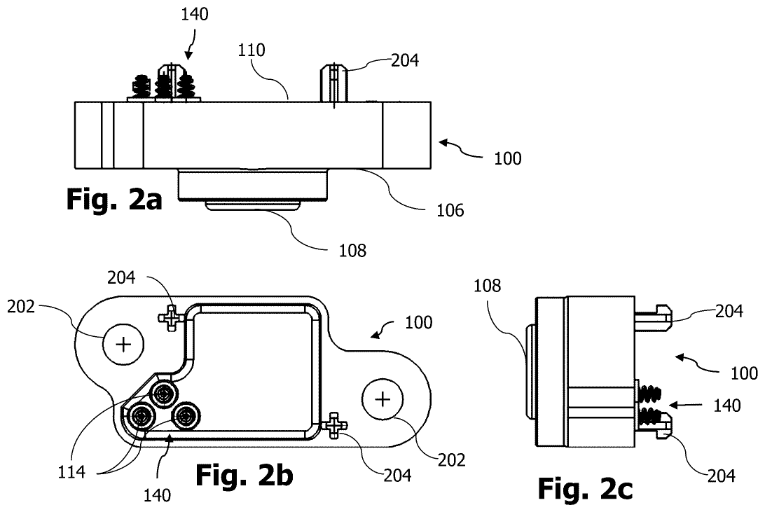

In accordance with an embodiment of the present disclosure, spring-based electronic contact junction 140 includes three springs 114 (see FIGS. 2a to 2c) on second side 110 of housing 104, and wherein three springs 114 (see FIGS. 2a to 2c) are electronic contact poles representing a supply connection, a ground connection, and a signal output connection. The technical purpose of providing three springs 114 (see FIGS. 2a to 2c) is, as derivable, to have distinct contact poles representing the supply, ground, and signal output connections and also facilitate complying with SENT (Single Edge Nibble Transmission) protocol according to SAE-J2716_1604 at the signal output connection, whereby Pulse Width Modulated (PWM) signal (which consumes a relatively less power during operation, but ensures high precision of readings) can be provided as an output of the pressure sensor readings. In particular, providing a SENT interface at the output connection of three springs 114 (see FIGS. 2a to 2c) enables a 12-bit fast data transfer channel with relatively higher data resolution.

In an embodiment of the present disclosure and/or in association with the embodiment of the previous paragraph, each of three springs 114 (see FIGS. 2a to 2c) has a spring rate in the range of 2.5 N/mm to 5 N/mm. In the present embodiment, the technical effect of providing the spring rate within the mentioned range enables in negating the effects of the vibration experienced by gearbox actuator 100 due to the operating environment in which it is used. Furthermore, the spring rate mentioned herein has a direct impact on the deflection allowed by three springs 114 (see FIGS. 2a to 2c), which has to be precisely calculated taking the context of the present disclosure e.g., reading pressure signals, receiving power supply, connecting to ground into account over the entire span of life of pressure sensor 102 into account. Thanks to the iterations performed in the testing jig for testing pressure sensor 102 with e.g., three springs 114 (see FIGS. 2a to 2c) having the spring rate as mentioned above, pressure sensor 102 in association with gearbox actuator 100 satisfy the loads applied thereupon as stipulated under ISO 16750-3, which relates to the environmental conditions and testing for electrical and electronic equipment, in particular to the mechanical loads experienced by the electrical and electronic equipment in road vehicles.

In a particular implementation of the present disclosure, spring-based electronic contact junction 140 is configured to compensate for the vibrations experienced by modular pressure sensor 102 between the frequency 20 to 2000 Hz. It is particularly noted that this frequency range of vibrations may find its relevancy in the context of, e.g., gearbox actuators, which is one of the potential areas of application of the modular pressure sensor according to the present disclosure. Such a tolerance for the vibrations experienced at modular pressure sensor 102 is not only required for complying with e.g., ISO 16750-3 standard, but also improves the life of pressure sensor 102. Due to usage of spring-based electronic contact junction 140 of the present disclosure, the life cycle of pressure sensor 102 can exceed 20,000 operating hours or 6×10⁶ pressure cycles between a minimum pressure threshold and a maximum pressure threshold e.g., within the specified data. This may correspond to a service life of 10 years.

Furthermore, springs 114 are made of stainless steel, and wherein at least one of the three springs 114 (see FIGS. 2a to 2c) is gold plated. In accordance with a specific implementation, all of three springs 114 are plated with gold. For instance, such plating can offer corrosion resistant properties to springs 114. In the same or different embodiment, springs 114 are coated with the gold plating includes at least 0.1 micrometer of Gold (Au) and about 0.5 to 3 micrometer of Nickel (Ni). In this specific implementation, Nickel (Ni) can act as a barrier metal protecting springs 114 from environmental factors.

In accordance with one or more embodiments discussed above, modular pressure sensor 102 is a piezoresistive sensor. A piezoresistive sensor, which operates based on the Wheatstone bridge principle whereby the change in resistances are converted into pressure values, provides number of technical benefits includes high precision in readings, high tolerance for withstanding excess pressure, high sensitivity, higher range of operation i.e., pressure range, and smaller construction in relation to other types of pressure sensor.

Furthermore, modular pressure sensor 102 is either a relative or an absolute pressure sensor, in accordance with one or more of the above embodiments. Preferably, modular pressure sensor 102 of the present disclosure is an absolute pressure, wherein the measured pressure value is an absolute value without any relation to the atmospheric pressure and/or a reference starting point is considered to be vacuum. Using absolute pressure sensor in the context of modular pressure sensor 102 provides the technical benefit of direct pressure readings within the system of gearbox actuator 100 without reference to any external factors including the atmospheric pressure.

In one or more embodiments of the present disclosure, housing 104 is made of a thermoplastic material incorporated with glass fiber. Mixing with glass fiber may yield more flexibility in terms of shape of housing 104 as well as keep housing 104 chemically inert under the circumstance of the environmental factors of gearbox actuator 100. Furthermore, housing 104 may be structurally more rigid and its physical properties such as stiffness and strength are enhanced due to the usage of glass fiber. In a preferred embodiment, Polybutylene terephthalate (PBT), with 30 percent of glass fiber i.e., PBT GF 30 is used as the material for making housing 104.

Moreover, in accordance with one or more of the above embodiments, modular pressure sensor 102 is configured to operate in an operating temperature range of −40 to +130 degrees Celsius. This is to enable and/ensure pressure sensor 102 remains intact under extreme operating conditions as well. Since gearbox actuators 100 may also be in closer proximity to high temperature components such as engines, such a high range of operating temperature requirements are necessary for pressure sensor 102 according to the present disclosure. Further, the if the vehicle including gearbox actuators 100 are used in really cold conditions and when the engine is turned off, modular pressure sensor 102 of the present disclosure is configured to withstand such relatively colder conditions and hence, the temperature range mentioned above is a necessity in certain circumstances. Modular pressure sensor 102 due to e.g., the choice of material of housing 104 enables such protection under highly varying external temperature conditions in relation to gearbox actuator 100 and keeps the electronic components present within it without any damage.

Finally, in one aspect, FIG. 1 also discloses gearbox actuator 100, which includes modular pressure sensor 102 in accordance with any one of the embodiments discussed above, wherein modular pressure sensor 102 is replaceably mounted onto the gearbox actuator 100. It is one of the key aspects of the present disclosure, wherein modular pressure sensor 102 is easily replaced when its life cycle is over or for whatever reasons, should be replaced. As discussed in one or more of the above sections, conventional pressure sensors had or have, among others, soldered junctions, which are hard to re-solder or hard to replace once the bonding at the junction is broken. With the use of spring-based electronic junction contact junction 140 of the present disclosure, pressure sensor 102 is replaceable in the sense, no further manufacturing operation such as soldering needs to be performed to connect the pressure sensor either directly or indirectly with a lead frame or a PCB or the flex foil.

In accordance with the same or different aspect, gearbox actuator 100 further includes a printed circuit board (PCB) 134, wherein the PCB 134 is either directly or indirectly connected to modular pressure sensor 102, and wherein gearbox actuator 100 additionally includes a wire trace 136 for bridging the connection between the at least two springs 114 and PCB 134.

FIG. 2a illustrates a front view of a modular pressure sensor in accordance with an embodiment of the present disclosure, FIG. 2b illustrates a top view of the modular pressure sensor explained in reference with FIG. 2a in accordance with an embodiment of the present disclosure, and FIG. 2c illustrates a side view of the modular pressure sensor explained in reference with FIGS. 2a and 2b in accordance with an embodiment of the present disclosure.

For the sake of convenience, the features and aspects that are to be explained in conjunction with FIGS. 2a to 2c are combined herewith. Furthermore, wherever the elements disclosed in FIGS. 2a to 2c are also perceivable in FIG. 1, same reference sign as that of FIG. 1 is used herewith.

In the present embodiment in association with FIG. 1 as well as FIGS. 2a to 2c, housing 104 is manufactured by injection molding process, and wherein modular pressure sensor 102 includes at least two holes 202, e.g., at housing 104. Holes 202 can be either threaded or non-threaded. Manufacturing by injection molding process provides considerable cost advantages in manufacturing a component in scale. As also explained in conjunction with the above embodiments, since e.g., housing 104 is made of thermoplastic including glass fibers, injection molding is the ideal manufacturing process. And furthermore, the dimensions of holes 202 are chosen based on the basic rules of injection molding and plastic design, whereby, for instance, the threads are optimal for the application of inserting attaching means through holes 202. In accordance with a specific implementation of the present disclosure, holes 202 are blind holes and the threads may be formed when a self-tapping screw is inserted into them.

Furthermore, each of the at least two holes 202 are configured to receive a fastener 132 for attaching the modular pressure sensor 102 to an external component. In accordance with an exemplary illustration, fastener 132 is a self-tapping screw. In accordance with an exemplary embodiment, fastener 132 is closed at its free end with a washer (not shown in any of the figures).

Still furthermore, as can be derived from FIGS. 2a to 2c, modular pressure sensor 102 further includes one or more protrusions 204 for positionally fixing modular pressure sensor 102 with respect to an external component such as gearbox actuator 102 after the assembly (of pressure sensor 102). For instance, protrusions 204 may assist in orienting pressure sensor 102 positionally in relation to a receiving external component i.e., the slot (not shown in FIG. 1 as well) of gearbox actuator 102 such that assembly is simplified.

1. A modular pressure sensor (102), comprising
a housing (104),
a first side (106) of the housing (104) comprising a pressurized fluid inlet (108),
a second side (110) of the housing (104) being opposite to the first side (106), and
a spring-based electronic contact junction (140) on the second side (110),
wherein the spring-based electronic contact junction (140) is configured to transfer electronic signals representing pressure of the fluid received at the pressurized fluid inlet (108) directly or indirectly to a lead frame or a flex foil or a Printed Circuit Board (PCB).

2. The modular pressure sensor (102) in accordance with claim 1, wherein the spring-based electronic contact junction (140) includes three springs (114) on the second side of the housing (104), and wherein the three springs (114) are electronic contact poles representing a supply connection, a ground connection, and a signal output connection.

3. The modular pressure sensor (102) in accordance with claim 2, wherein each of the three springs (114) has a spring rate in the range of 2.5 N/mm to 5 N/mm.

4. The modular pressure sensor (102) in accordance with claim 2, wherein the three springs are made of stainless steel, and wherein at least one of the three springs is gold plated.

5. The modular pressure sensor (102) in accordance with claim 4, wherein the gold plating includes at least 0.1 micrometer of Gold (Au) and about 0.5 to 3 micrometer of Nickel (Ni).

6. The modular pressure sensor (102) in accordance with claim 1, wherein the spring-based electronic contact junction compensates (140) for vibrations experienced by the modular pressure sensor (102) between the frequency 20 to 2000 Hz.

7. The modular pressure sensor (102) claim 1, wherein the housing (104) is injection molded, and wherein the modular pressure sensor (102) includes at least two holes (202), which are threaded or non-threaded.

8. The modular pressure sensor (102) in accordance with claim 7, wherein each of the at least two holes (202) are configured to receive a fastener (132) for attaching the modular pressure sensor (102) to an external component.

9. The modular pressure sensor (102) in accordance with claim 1, wherein the modular pressure sensor (102) further comprises one or more protrusions (204) configured to positionally fix the modular pressure sensor (102) with respect to an external component such as a gearbox actuator (102) after the assembly.

10. The modular pressure sensor (102) in accordance with claim 1, wherein the modular pressure sensor (102) is a piezoresistive sensor.

11. The modular pressure sensor (102) in accordance with claim 1, wherein the modular pressure sensor (102) is a relative or an absolute pressure sensor.

12. The modular pressure sensor (102) in accordance with claim 1, wherein the housing (104) is made of a thermoplastic material incorporated with glass fiber.

13. The modular pressure sensor (102) in accordance with claim 1, wherein the modular pressure sensor (102) is configured to operate in an operating temperature range of −40 to +130 degrees Celsius.

14. A gearbox actuator (100), comprising the modular pressure sensor (102) in accordance with claim 1, wherein the modular pressure sensor (102) is releasably mounted onto the gearbox actuator (100).

15. The gear box actuator (100) of claim 14, wherein the gearbox actuator (100) further comprises a Printed Circuit Board (PCB) (134), as a part of an Electronic Control Unit (ECU) associated with the gearbox actuator (100), wherein the PCB (134) is directly or indirectly connected to the modular pressure sensor, and wherein the gearbox actuator (100) additionally comprises a wire trace (136) that bridges a connection between the at least two springs (114) and the PCB (134).

16. The modular pressure sensor (102) in accordance with claim 2, wherein the three springs provide a SENT (Single Edge Nibble Transmission) protocol interface at the signal output connection.

17. The modular pressure sensor (102) in accordance with claim 11, wherein the modular pressure sensor (102) is an absolute pressure sensor, wherein a measured pressure value is an absolute value.
